(19) United States
(12) Patent Application Publication
(10) Pub. No.: US 2025/0185094 A1
(43) Pub. Date: Jun. 5, 2025

(54) METHODS, AND NETWORK NODES FOR HANDLING COMMUNICATION IN A WIRELESS COMMUNICATIONS NETWORK

(71) Applicant: Telefonaktiebolaget LM Ericsson (publ), Stockholm (SE)

(72) Inventors: Martin SKARVE, Enebyberg (SE); Samir SHAH, Ottawa (CA); Svante JÄRVSTRÅT, Linköping (SE); Stefan ENG, Linköping (SE); Björn KNUTHAMMAR, Linköping (SE); Torbjörn ÖRTENGREN, Linköping (SE)

(21) Appl. No.: 18/729,131

(22) PCT Filed: Feb. 11, 2022
(86) PCT No.: PCT/EP2022/053418

§ 371 Date: Jul. 15, 2024

(51) Int. Cl. H04W 76/15; H04W 72/1263

(52) U.S. Cl. CPC H04W 76/15; H04W 72/1263

(57) ABSTRACT

Embodiments herein relate to, for example, a method performed by a first network node hosting a PDCP entity for handling communication of a UE in a wireless communications network. The first network node receives from one or more corresponding network nodes, an indication of a delay related to scheduling of data communication over an air interface between respective corresponding network node and the UE. The first network node further performs one or more actions related to aggregating PDCP communication over a split radio bearer between the first network node and two or more corresponding network nodes based on the received indication.

### TECHNICAL FIELD

Embodiments herein relate to a first network node, a corresponding network node, and methods performed therein regarding wireless communication. Furthermore, a computer program and a computer readable storage medium are also provided herein. In particular, embodiments herein relate to handling communication, such as deactivating or activating packet data convergence protocol (PDCP) aggregation, in a wireless communications network.

### BACKGROUND

In a typical wireless communications network, user equipments (UE), also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node e.g. a Wi-Fi access point or a radio base station (RBS), which in some networks may also be called, for example, a NodeB, a gNodeB, or an eNodeB. The service area or cell area is a geographical area where radio coverage is provided by the radio network node. One or more radio network nodes operate on radio frequencies to communicate over an air interface with the UEs within range of the radio network node. Respective radio network node communicates over a downlink (DL) to the UE and the UE communicates over an uplink (UL) to the respective radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 6G networks and development of 5G such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Dual Connectivity (DC) is specified in 3GPP specifications for LTE and NR and is used to enable a split Radio Bearer (RB) to transmit user data to a UE using two radio nodes. DC is for example required for the very first 5G technology, EUTRA-NR Dual Connectivity (EN-DC), when one eNB is connected to a gNB using the specified X2 interface. A gNB can according to 3GPP be further split into the following nodes: Central Unit-Control Plane (gNB-CU-CP), Central Unit-User Plane (gNB-CU-UP) and Distributed Unit (gNB-DU). Disclosure is related to the User Plane (UP) why no further explanations are made on the Control Plane parts.

A Split RB has one Packet Data Convergence Protocol (PDCP) entity located in the gNB or gNB-CU-UP, here referred to as network node hosting PDCP entity, and two network nodes with entities for lower protocol layers, here referred to as corresponding network nodes.

As shown in FIG. 1, a split RB may transmit user data over both or one of the two radio interfaces (legs). The latter is referred to as PDCP aggregation in this document. Benefits are, among others, introducing a higher peak rate than using only a single leg.

The user data transmission from the network node hosting PDCP entity to the corresponding nodes may be controlled by a Flow Control (FC) function. FC maintains a short, but not too short radio link control (RLC) service data unit (SDU) buffer size in each of the corresponding nodes, with the purpose to achieve the same total transmission delay for the user data packets independent of which corresponding node that is used for communication, see FIG. 2. The performance when using PDCP aggregation in DC is highly dependent on achieving a minimal reordering difference between packets sent over the two corresponding network nodes and received by the UE.

### SUMMARY

As part of developing embodiments herein one or more problems have been identified. With increased reordering between packets, the risk for reduced performance increases due to transmission control protocol (TCP) effects such as TCP window data stalling. When the reordering between packets becomes too high the PDCP Aggregation can perform worse than if only one of the two corresponding network nodes was used for transmission. In such cases it would be optimal if PDCP Aggregation is deactivated for the Split Radio Bearer.

The FC feedback from corresponding nodes to the node hosting PDCP is specified in 38.425 as Downlink Data Delivery Status (DDDS) and is sent per RB. The FC algorithm as such is not specified by 3GPP. The DDDS includes information such as highest transmitted and delivered PDCP Sequence Number, desired data rate and packets lost over the transport link serving as input to the FC algorithm in the network node hosting the PDCP entity.

When the cell load increases, it is not possible for the scheduler, scheduling communication over the air interface, to schedule each UE according to its needs, and the time between each air interface scheduling occasion increases with the cell load. The longer time between each scheduling for a particular split RB the higher risk for increased reordering of packets in the UE and therefore reduced performance of the PDCP aggregation.

Current 3GPP specification 38.425 v. 17.0.0 does not include signalling of the air interface scheduling delay or when the air interface scheduling delay reaches a predefined value to the network node hosting the PDCP entity so that, e.g., the FC may stop PDCP Aggregation.

The 3GPP supported way to do this today is that the node hosting PDCP polls each corresponding node continuously for DDDS and follows any change in Transmitted PDCP Sequence Number, as it is the only way to identify an air interface scheduling. This method requires very frequent polling sent in protocol data unit (PDU) frames on the downlink interface towards corresponding nodes. In addition, a corresponding node is then required to respond to the poll and send a DDDS as a response. This means that the node hosting PDCP, the corresponding nodes and the interconnecting interfaces will experience increased load.

When PDCP Aggregation is not yet activated, the only 3GPP supported method to identify if the cell load is low enough to support PDCP Aggregation is to probe sending new use data packets to the corresponding nodes and poll for DDDS feedback. This will increase the load further and also introduce a delay before PDCP Aggregation can be activated.

An object herein is to provide a mechanism to enable communication, for example, handle DC communication, in an efficient manner in a wireless communications network.

According to an aspect the object is achieved, according to embodiments herein, by providing a method performed by a first network node hosting a PDCP entity such as a central unit of a radio network node for handling communication of a UE in a wireless communications network. The first network node receives from one or more corresponding network nodes, such as distributed units of the radio network node, an indication of a delay related to scheduling of data communication over an air interface between respective corresponding network node and the UE. The first network node performs one or more actions related to aggregating PDCP communication over a split radio bearer between the first network node and two or more corresponding network nodes based on the received indication.

According to another aspect the object is achieved, according to embodiments herein, by providing a method performed by a corresponding network node for handling communication to a UE in a wireless communications network. The corresponding network node transmits to a first network node hosting a PDCP entity for the corresponding network node, an indication of a delay related to scheduling of data communication over an air interface to the UE.

According to yet another aspect the object is achieved, according to embodiments herein, by providing a first network node and a corresponding network node configured to perform the methods herein, respectively.

Thus, according to still another aspect the object is achieved, according to embodiments herein, by providing a first network node hosting a PDCP entity, such as a central unit of a radio network node, for handling communication of a UE in a wireless communications network. The first network node is configured to receive from one or more corresponding network nodes, such as distributed units of the radio network node, an indication of a delay related to scheduling of data communication over an air interface between respective corresponding network node and the UE. The first network node is further configured to perform one or more actions related to aggregating PDCP communication over a split radio bearer between the first network node and two or more corresponding network nodes based on the received indication.

According to yet still another aspect the object is achieved, according to embodiments herein, by providing a corresponding network node for handling communication to a UE in a wireless communications network. The corresponding network node is configured to transmit to a first network node hosting a PDCP entity for the corresponding network node, an indication of a delay related to scheduling of data communication over an air interface to the UE.

It is furthermore provided herein a computer program product comprising instructions, which, when executed on at least one processor, cause the at least one processor to carry out the method above, as performed by the first network node and the corresponding network node, respectively. It is additionally provided herein a computer-readable storage medium, having stored thereon a computer program product comprising instructions which, when executed on at least one processor, cause the at least one processor to carry out the method according to the method above, as performed by the first network node and the corresponding network node, respectively.

Embodiments herein provide one or more advantages:
1) no or very limited load on RAN since PDCP aggregation may be used based on load on a split radio bearer; and
2) faster compared to the current available 3GPP based method since controlling the PDCP aggregation is based on the received indicated delay of scheduling communication of the UE.

The corresponding network node such as a DU, identifies a high load situation during ongoing transmission or when there is a need to identify the load situation before activating PDCP aggregation and there is no current traffic on the bearer. The first network node hosting the PDCP entity may then take action to mitigate the negative performance impact for DC radio bearers, for example deactivate PDCP Aggregation.

Thus, embodiments herein enable a communication, e.g., handle or manage signalling/communication, in an efficient manner in a wireless communications network.

### BRIEF DESCRIPTION OF THE DRAWINGS

Embodiments will now be described in more detail in relation to the enclosed drawings, in which:

FIG. 1 shows a schematic overview depicting a split bearer architecture according to prior art;

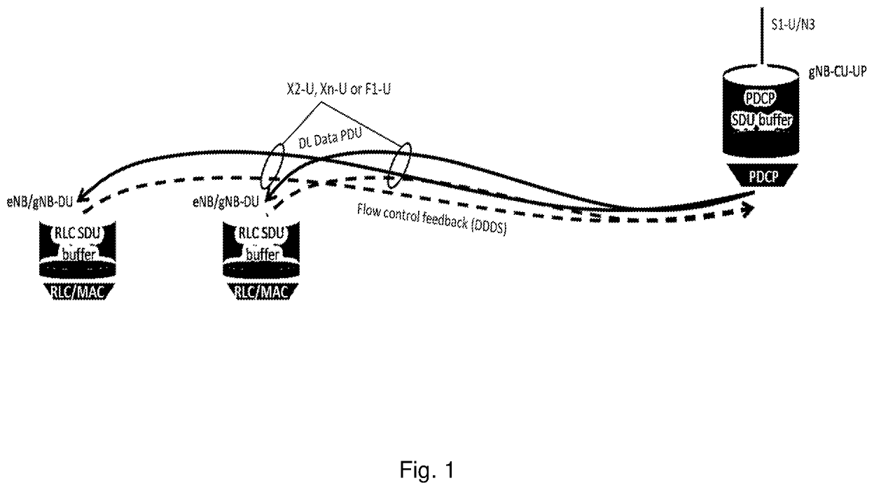

FIG. 2 shows a schematic overview depicting one leg of a split bearer architecture according to prior art;

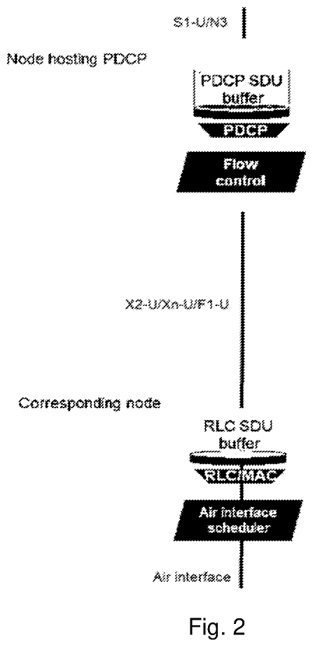

FIG. 3 shows an overview depicting a wireless communications network according to embodiments herein;

FIG. 4a shows a combined signalling scheme and flowchart depicting embodiments herein;

FIG. 4b shows a combined signalling scheme and flowchart depicting embodiments herein;

FIG. 5 shows a flowchart illustrating a method performed by a first network node according to embodiments herein;

FIG. 6 shows a flowchart illustrating a method performed by a corresponding network node according to embodiments herein;

FIG. 7 shows an overview depicting a wireless communications network according to embodiments herein;

FIG. 8 shows a block diagram depicting a DDDS according to embodiments herein;

FIG. 9 shows a block diagram depicting a AID according to embodiments herein;

FIG. 10 shows a block diagram depicting a polling message according to embodiments herein;

FIG. 11 shows a flowchart illustrating a method according to embodiments herein;

FIG. 12 shows a flowchart illustrating a method according to embodiments herein;

FIGS. 13a-13b shows a block diagram depicting embodiments of a corresponding network node according to embodiments herein;

FIGS. 14a-14b shows a block diagram depicting embodiments of a first network node according to embodiments herein;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17, 18, 19, and 20 are flowcharts illustrating methods implemented in a communication system including a host computer, a base station and a user equipment.

### DETAILED DESCRIPTION

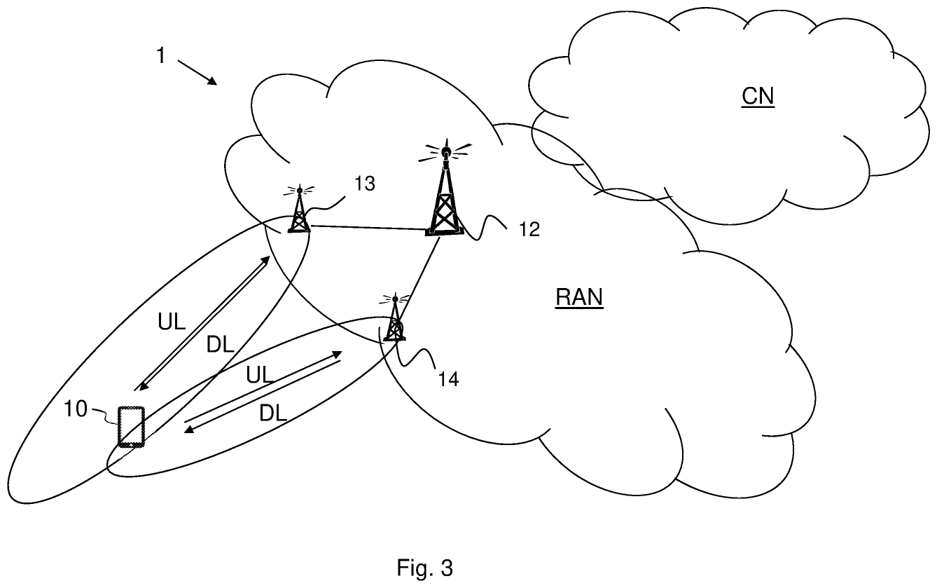

Embodiments herein relate to wireless communications networks in general. FIG. 3 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a UE 10 such as a mobile station, a wireless device, a non-access point (non-AP) STA, a STA, and/or a wireless terminal, is comprised communicating via e.g. one or more Access Networks (AN), e.g. RAN, to one or more core networks (CN). It should be understood by the skilled in the art that “UE” is a non-limiting term which means any terminal, wireless communications terminal, user equipment, Internet of things (IoT) capable device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises one or more radio network nodes such as e.g. an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a stand-alone access point or any other network unit or node capable of communicating with a UE within a service area served by the radio network node depending e.g. on a first radio access technology and terminology used. The one or more radio network nodes may also be referred to as serving or source node or RAN node. It should be noted that a service area of a radio network node may be denoted as cell, beam, beam group or similar to define an area of radio coverage.

According to embodiments herein the wireless communications network 1 comprises a first network node 12 hosting a PDCP entity and two or more corresponding network nodes 13,14. A corresponding network node may correspond to the first network node 12 by comprising an RLC entity connected over a split radio bearer (or link) to the PDCP entity in the first network node 12. In one example a radio network node may comprise a split CU-DU architecture. Thus, the first network node 12 may comprise a central unit of, e.g., an access node, an access controller, a base station, e.g. a radio base station such as a gNodeB (gNB), an evolved Node B (eNB, eNode B), a NodeB, a base transceiver station, an Access Point Base Station, a base station router, a Wireless Local Area Network (WLAN) access point or an Access Point Station (AP STA). The central unit hosts the PDCP entity aggregating communication of two or more RLC entities of corresponding distributed units, such as a first DU and a second DU, e.g., a radio remote unit, comprising a respective RLC entity. The respective DU provides radio coverage over a respective geographical area, e.g., a first cell and a second cell, of a respective radio access technology (RAT), such as NR, LTE, or similar.

According to embodiments herein a corresponding network node 13 transmits to the first network node 12, an indication of a delay related to scheduling of data communication over an air interface between respective corresponding network node 13, 14 and the UE 10. The first network node 12 performs one or more actions related to aggregating PDCP communication over a split radio bearer between the first network node and two or more corresponding network nodes based on the received indication. The first network node may, for example, activate or deactivate PDCP aggregation over the split radio bearer based on the indication.

The indication may be transmitted without receiving a request for said indication or upon receiving a polling message. The polling may be performed using an existing polling message or a new message.

The indication may comprise feedback messages from the corresponding network node 13, such as DDDS messages, indicating the delay implicitly, or the indication may comprise one or more messages comprising a value or index of the delay that may be transmitted upon fulfilling a condition related to a level of the delay. The indication may alternatively be transmitted periodically.

Embodiments herein may detect when a level of delay for scheduling over the air interface exceeds a set threshold level, The delay may be due a low priority over the air interface or a high load. The first network node 12 may then adjust PDCP aggregation avoiding a low performance of the PDCP aggregation.

Embodiments herein may also be implemented between gNB-gNB or eNB-gNB. The user plane interfaces may be interfaces defined by the 3gpp spec 38.425 v. 17.0.0.

Embodiments herein may describe a DL use case, but are also applicable to UL use case with a corresponding indication of the scheduling delay in UL.

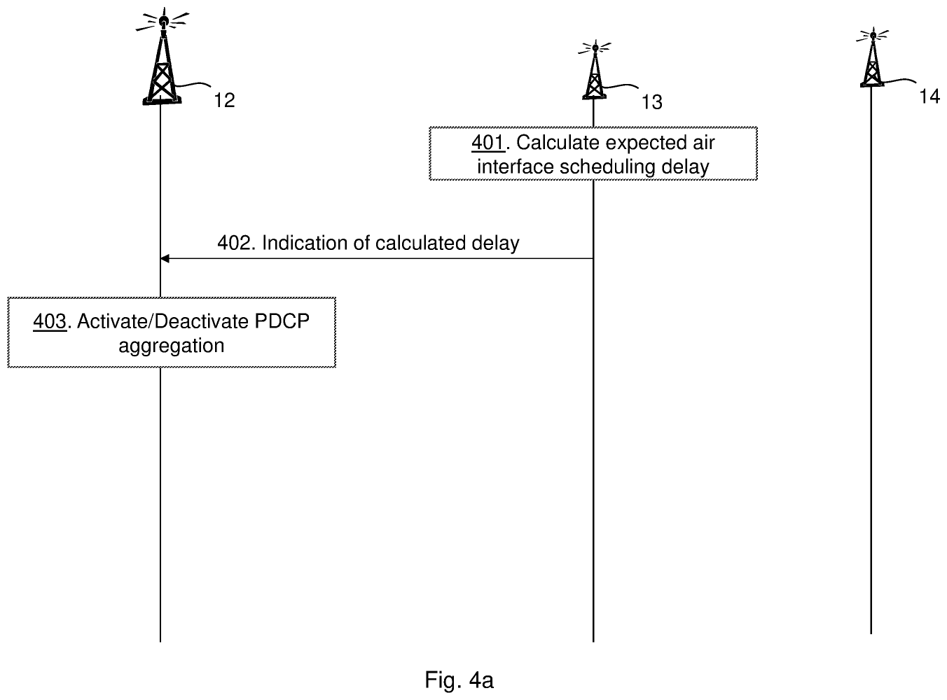

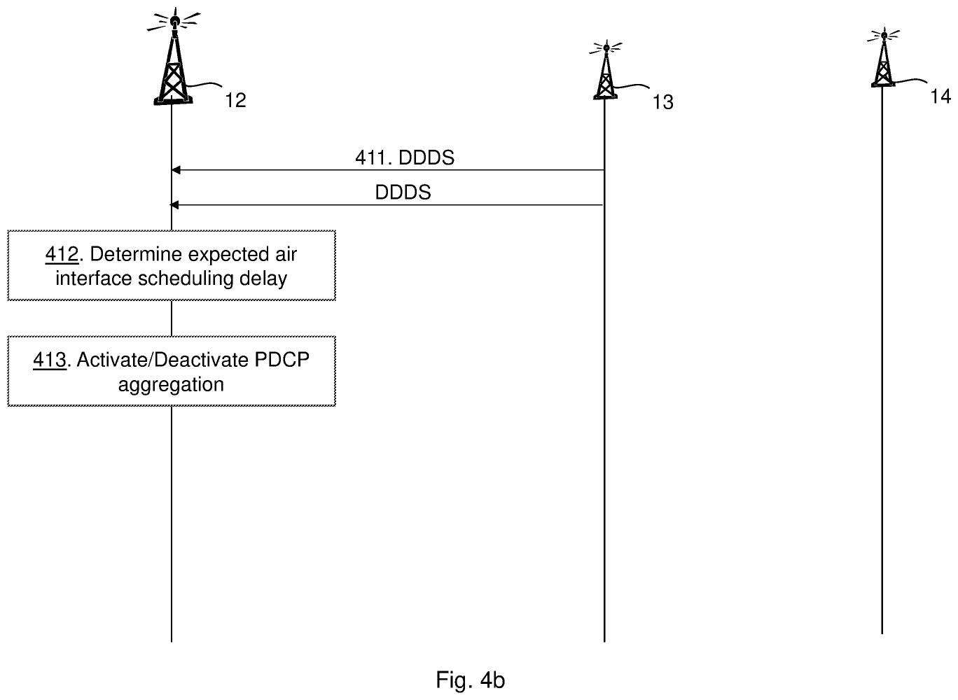

FIG. 4a shows a combined flowchart and signalling scheme according to some embodiments herein.

Action 401. The corresponding network node 13 may determine an expected air interface scheduling delay. That is, the delay between scheduling communication, UL/DL, for the UE 10. The corresponding network node 13 may determine, for example, measure, estimate or calculate, the expected air interface scheduling delay at the corresponding network node 13. The expected air interface scheduling delay may be an indication of high load when being over a threshold.

Action 402. The corresponding network node 13 transmits to the first network node 12 hosting the PDCP entity, the indication of the calculated expected air interface scheduling delay. The indication may be a value or an index of the calculated expected air interface scheduling delay.

Action 403. The first network node 12 receives the indication and based on the indication the first network node 12 may deactivate or active PDCP aggregation over the split radio bearer between the first network node 12 and the corresponding network nodes.

FIG. 4b shows a combined flowchart and signalling scheme according to some embodiments herein.

Action 411. The corresponding network node 13 transmits to the first network node 12 hosting the PDCP entity, a respective feedback message each scheduling occasion for the UE over the split radio bearer. Thus, the indication may comprise a number of feedback messages related to scheduling of the UE 10, for example, DDDS messages.

Action 412. The first network node 12 may receive the feedback messages and determine the expected air interface scheduling delay based on the received feedback messages. For example, determine time interval between the received feedback messages and compare the time interval with a delay threshold to detect a high load on the split link for the corresponding network node 13 over the air interface to the UE 10.

Action 413. The first network node 12 may then perform an action such as deactivate or active PDCP aggregation over the split radio bearer between the first network node 12 and the corresponding network nodes, based on the determined expected air interface scheduling delay. For example, the first network node 12 may, when the expected air interface scheduling delay is over the threshold, deactivate PDCP aggregation or request to prioritize radio resources of the air interface for communication of the split radio bearer.

Embodiments propose a new approach to identify high cell load and take action to reduce the possible negative PDCP Downlink Aggregation performance impact.

For example, the corresponding network node 13 may measure or calculate the expected air interface scheduling delay for a radio bearer and may signal the result to the first network node 12 hosting the PDCP entity. The indication may be comprised in a new information field in the DDDS or Assistance Information Data (AID) protocol data unit may be used. This is illustrated in Action 402.

Alternatively; the corresponding network node 13 may send DDDS autonomously at every air interface scheduling for a particular split RB, also referred to as split link. This is illustrated in Action 411.

The first network node 12 hosting the PDCP entity may identify a high cell load situation based on DDDS/AID content (action 402) or DDDS intensity (action 411). When the first network node 12 has identified a high load situation for at least one corresponding network node out of the two corresponding network nodes, the first network node 12 acts for improved performance of the PDCP aggregation. Such actions can be one or more of the following:
a) deactivate PDCP Aggregation, which means no transmission of DL data to more than one leg.
b) request increased air interface priority for the bearer, for example, allocate more air resource for communication over one leg.
c) send PDCP PDUs earlier to the high load leg to reduce the reordering between the two legs.

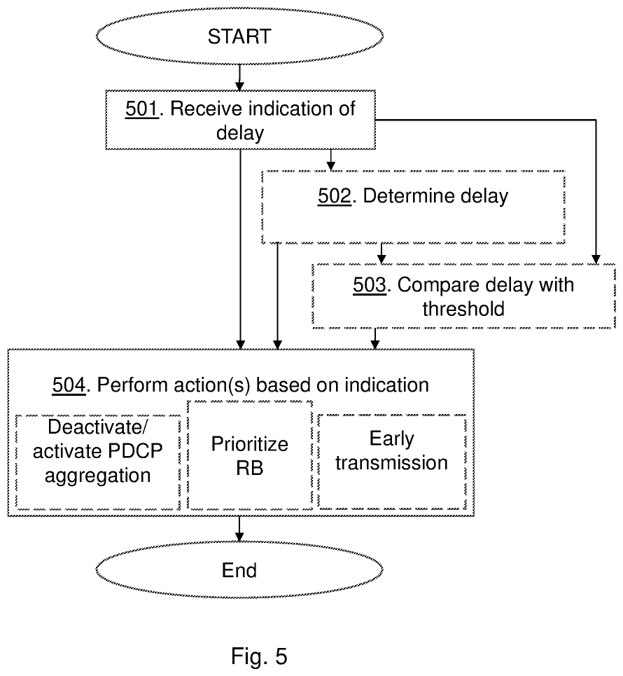

The method actions performed by the first network node 12 hosting the PDCP entity for handling communication of the UE 10 in the wireless communications network 1 according to embodiments herein will now be described with reference to a flowchart depicted in FIG. 5. The actions do not have to be taken in the order stated below, but may be taken in any suitable order. Dashed boxes indicate optional features.

Action 501. The first network node 12 receives from one or more corresponding network nodes, the indication of the delay related to scheduling of data communication over the air interface between respective corresponding network node and the UE 10. The indication may comprise a value indicating the delay being an expected air interface scheduling delay of the respective corresponding network node.

Action 502. The first network node 12 may determine, when the indication comprises feedback messages, the delay, being the expected air interface scheduling delay of the respective corresponding network node, based on the received feedback messages. For example, the first network node 12 may estimate or calculate the delay.

Action 503. The first network node 12 may compare the indicated delay with a threshold and when exceeding the threshold performing the one or more actions in action 504.

Action 504. The first network node 12 further performs one or more actions related to aggregating PDCP communication over the split radio bearer between the first network node and the two or more corresponding network nodes based on the received indication. For example, the first network node 12 may deactivate or activate the PDCP aggregation at the first network node 12. The one or more actions may comprise: prohibiting PDCP aggregation; giving higher priority to radio bearer in a loaded corresponding network node; and/or performing earlier transmission of one or more packets over a leg of the split radio bearer. Thus, the first network node may request resources of air interface and/or schedule transmissions over legs. The first network node 12 may select which of the corresponding network nodes is most appropriate to use. The selection may be based on air interface latency, i.e., the first network node 12 may select the corresponding network node with a lowest latency.

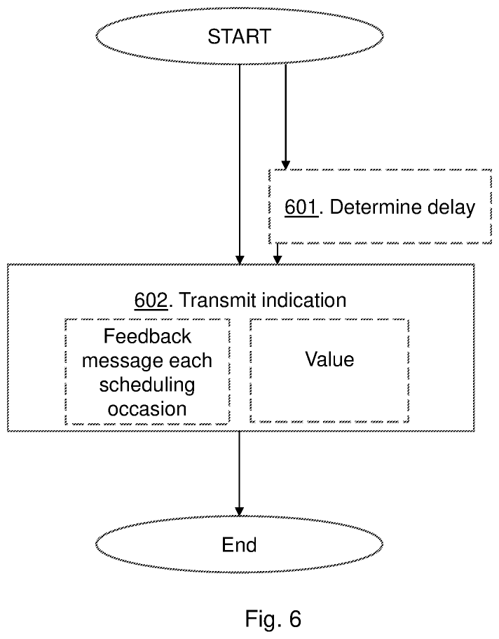

The method actions performed by the corresponding network node 13 for handling communication of the UE 10 in the wireless communications network 1 according to embodiments herein will now be described with reference to a flowchart depicted in FIG. 6. The actions do not have to be taken in the order stated below, but may be taken in any suitable order. Dashed boxes indicate optional features.

Action 601. The corresponding network node 13 may determine the delay at the corresponding network node 13. For example, the corresponding network node 13 may estimate or calculate the delay.

Action 602. The corresponding network node 13 transmits to the first network node 12 hosting the PDCP entity for the corresponding network node 13, the indication of the delay related to scheduling of data communication over the air interface to the UE 10. The indication may comprise a value indicating the delay, being an expected air interface scheduling delay of the corresponding network node 13. The corresponding network node 13 may transmit the indication upon fulfilling a condition related to a level of the delay, for example, being over a delay threshold or similar. The corresponding network node 13 may transmit the indication by transmitting a feedback message autonomously at every scheduling of data for the UE 10 of the split radio bearer to the first network node 12. The indication may be for communication related to the split radio bearer between the first network node and the two or more corresponding network nodes. The indication may be transmitted without receiving a request for said indication or upon receiving a polling message from the first network node 12; transmitted periodically; and/or transmitted upon fulfilling a condition related to a level of the delay. The indication may be transmitted at configuration time only.

Embodiments herein relate to an architecture comprising at least two network nodes. The method may be split into a first action and a second action, where the first action has two variants, which can be used individually or combined into one solution.

The first action covers where the corresponding network node 13 enables the delay, such as expected air interface scheduling delay, information towards the first network node 12.

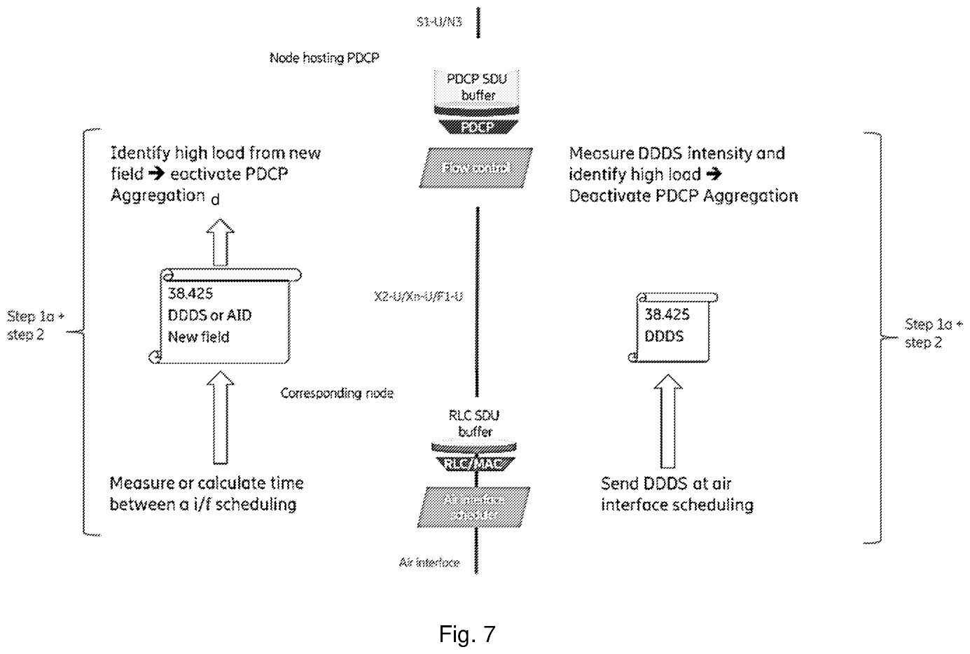

In the second action, the first network node 12 evaluates the received “expected air interface scheduling delay” information and decides if PDCP DL aggregation may be allowed/useful, and if not, the first network node 12 takes action to avoid a poorly behaving PDCP Aggregation. There can be different actions, such as prohibiting PDCP DL Aggregation, giving higher priority to radio bearer in the loaded corresponding node or taking other actions such as earlier transmission of packets. This is illustrated in FIG. 7.

The corresponding network node 13 may estimate, calculate or measure the expected air interface scheduling delay being an example of the delay related to scheduling of data communication over the air interface to the UE 10. The information then needs to be conveyed to the first network node 13. The corresponding network node 13 may include explicit signaling of the delay information, and/or implicitly send the delay information to the first network node 12 by generating DDDS at the same interval as the air interface scheduling for the radio bearer, thus, not requiring any 3GPP updates, and may be purely implementational.

There may be updates in 3GPP 38.425 for explicitly signalling the delay information according to below.

Below are two 3GPP 38.425 update alternatives where there is a need for the corresponding network node 13, such as a DU, to signal the expected air interface scheduling delay information to the first network node 12 such as a CU or a CU-UP on a per RB basis.

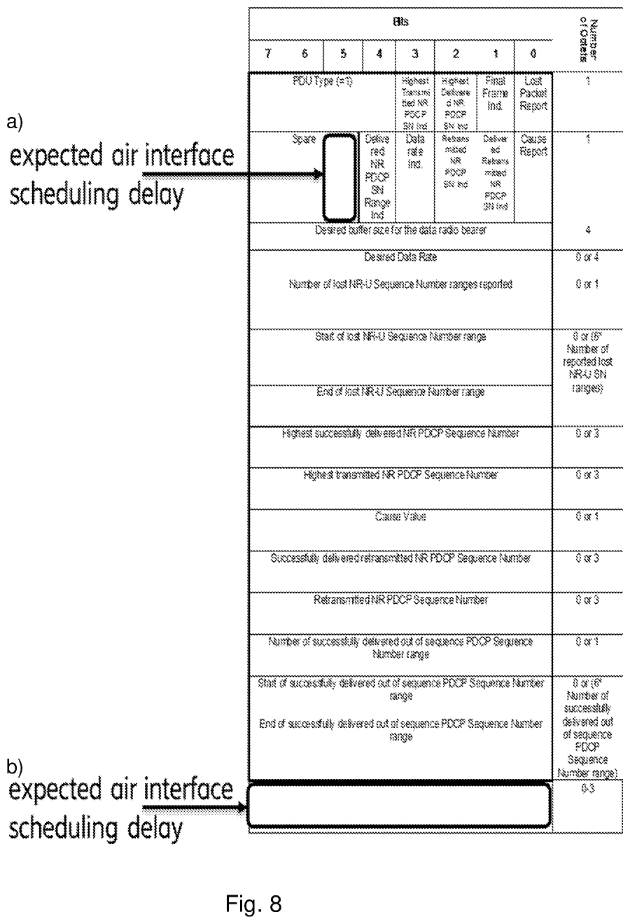

Alternative 1: As shown in FIG. 8. DL Data Delivery Status (DDDS) PDU may be updated to include:
a) a new indication flag in a message to indicate there is an expected air interface scheduling delay information field in the message; and
b) a new expected air interface scheduling delay information field.

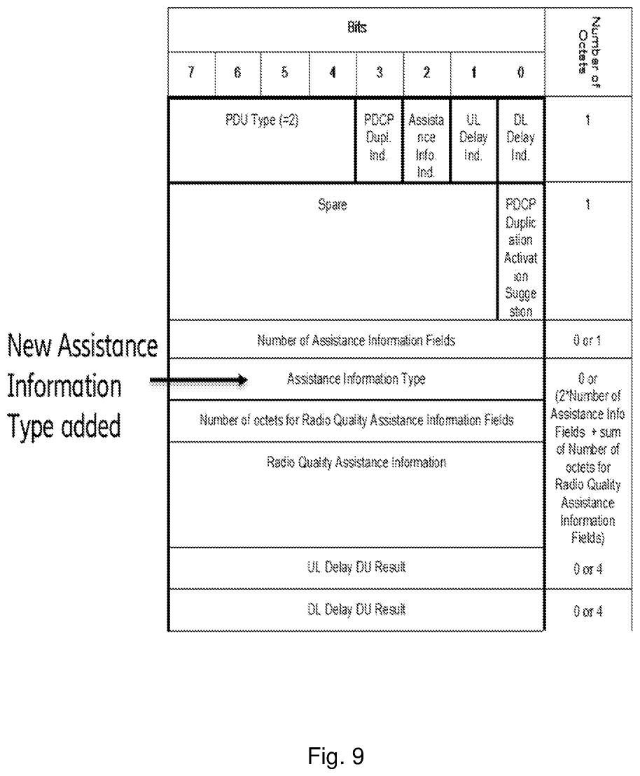

Alternative 2: AID PDU can be updated to include a new Assistance Information Type for expected air interface scheduling delay information, for example using a new index number, such as index 7, shown in FIG. 9. Assistance information type is a field describing the type of radio quality assistance information provided, if supported, by the corresponding node to the node hosting the NR PDCP entity. The DL radio quality index is a numerical index expressing the radio quality of the data radio bearer or the RLC entity in DL, wherein the value 0 represents the lowest quality. The UL radio quality index is a numerical index expressing the radio quality of the data radio bearer or the RLC entity in the UL, where the value 0 represents the lowest quality. The averaging window for the Average CQI, Average HARQ failure and average HARQ retransmissions set by means of configuration. Power headroom report (PHR) is PHR MAC control element reported by as defined in 3GPP TS 36.321 and 3GPP TS 38.321. Value range: 0=unknown 1=average CQI 2=average HARQ failure 3=Average HARQ retransmissions, 4=DL radio quality index, 5=UL radio quality index, 6=PHR, 7=expected air interface scheduling delay, 8-228 reserved for future extensions, 229-255=reserved for test purposes.

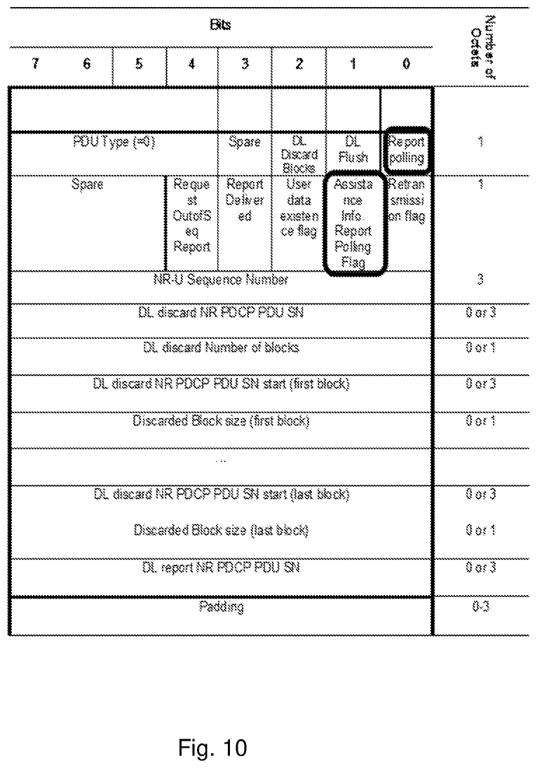

It shall be noted that 38.425 v. 17.0.0 today supports CU-UP polling for any of the alternative 1 and 2 above. See DL DATA PDU Type 0. Meaning that the first network node 12 hosting the PDCP entity may poll for any of DDDS or Assistance Information Data including expected air interface scheduling delay whenever it is required, as shown in FIG. 10.

Embodiments are applicable in a cloud environment in a similar way as described herein.

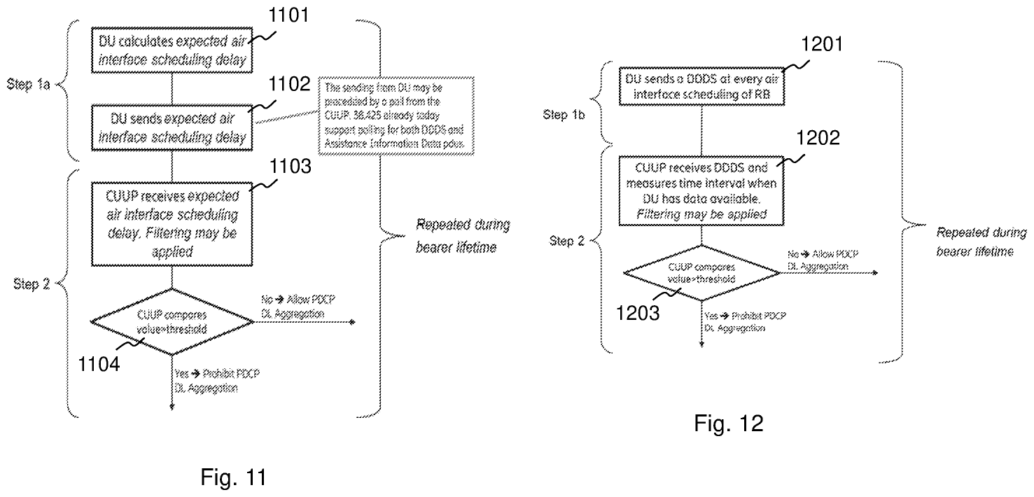

FIG. 11 shows a flowchart according to some embodiments herein. The corresponding network node 13 is exemplified as a DU and the first network node 12 is exemplified as a central unit such as a CU-UP.

Action 1101. The DU may calculate expected air interface scheduling delay.

Action 1102. The DU may send the expected air interface scheduling delay. The sending from the DU may be proceeded by a poll from the CU-UP. TS38.425 today supports polling for both DDDS and AID PDUs.

Action 1103. The CU-UP received the expected air interface scheduling delay e.g. being a value. The CU-UP may apply filtering to avoid a ping-pong effect between deactivation and activation, for example, a low pass filtering to average out big variations.

Action 1104. The CU-UP compares value>threshold. When the value is not higher than the threshold, the CU-UP may allow PDCP DL aggregation. When the value is higher than the threshold, the CU-UP may prohibit PDCP DL aggregation. When prohibiting the PDCP DL aggregation the CU-CP may that one corresponding network node out of the two will be used. The first network node 12 may select which of the corresponding network nodes is most appropriate to use. The selection may be based on air interface latency, i.e., the first network node 12 may select the corresponding network node with a lowest latency.

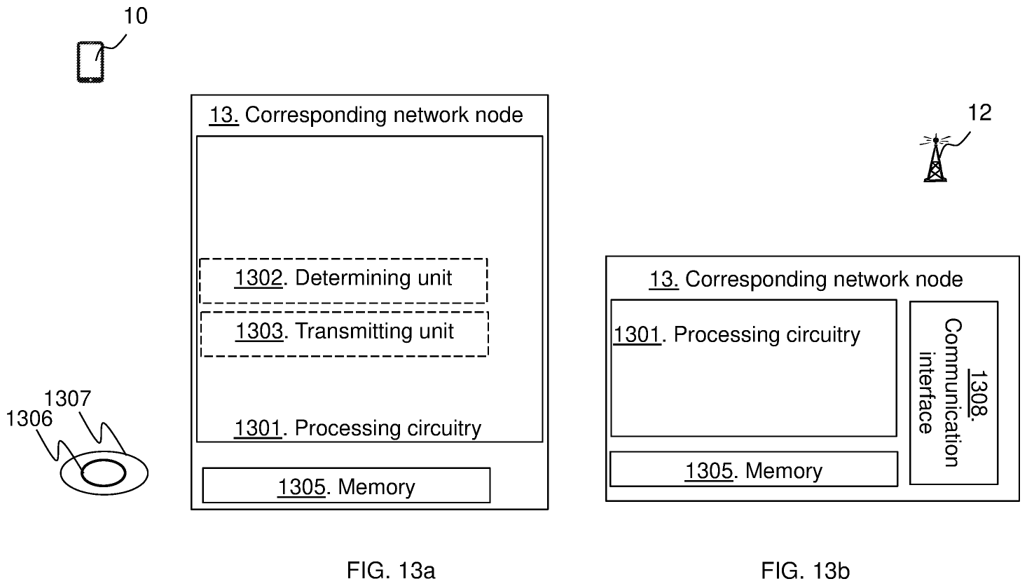

FIG. 12 shows a flowchart according to some embodiments herein. The corresponding network node 13 is exemplified as a DU and the first network node 12 is exemplified as a CU-UP.

Action 1201. The DU sends a DDS at every air interface scheduling of RB.

Action 1202. The CU-UP receives DDDS and measures time interval when DU has data available resulting in a value. The CU-UP may apply filtering see action 1103.

Action 1203. The CU-UP compares value>threshold. When the value is not higher than the threshold, the CU-UP may allow PDCP DL aggregation. When the value is higher than the threshold, the CU-UP may prohibit PDCP DL aggregation. When prohibiting the PDCP DL aggregation the CU-UP may that one corresponding network node out of the two will be used. The first network node 12 may select which of the corresponding network nodes is most appropriate to use. The selection may be based on air interface latency, i.e., the first network node 12 may select the corresponding network node with a lowest latency.

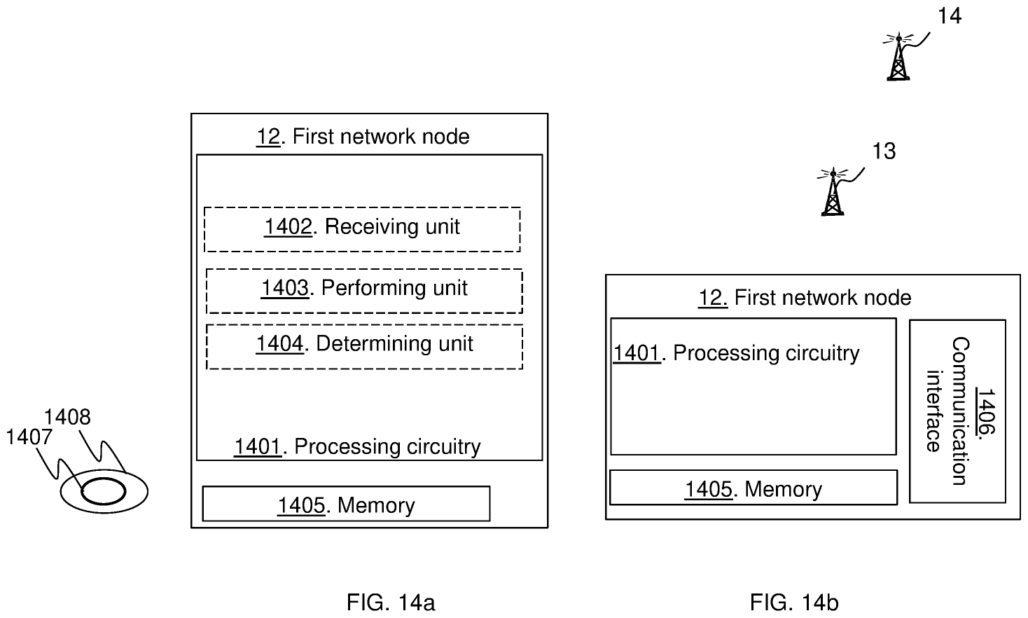

FIGS. 13a-13b are block diagrams depicting the corresponding network node 13 such as a DU, for handling communication of the UE 10 in the wireless communications network 1 according to embodiments herein.

The corresponding network node 13 may comprise processing circuitry 1301, e.g., one or more processors, configured to perform the methods herein.

The corresponding network node 13 may comprise a determining unit 1302. The corresponding network node 13, the processing circuitry 1301, and/or the determining unit 1302 may be configured to determine the delay at the corresponding network node 13.

The corresponding network node 13 may comprise a transmitting unit 1303, e.g. a transmitter or a transceiver. The corresponding network node 13, the processing circuitry 1301, and/or the transmitting unit 1303 is configured to transmit to the first network node 12 hosting the PDCP entity for the corresponding network node 13, the indication of the delay related to scheduling of data communication over the air interface to the UE 10. The indication may comprise a value indicating the delay, being an expected air interface scheduling delay of the corresponding network node 13. The corresponding network node 13, the processing circuitry 1301, and/or the transmitting unit 1303 may be configured to transmit the indication upon fulfilling a condition related to a level of the delay, for example, being over a delay threshold or similar. The corresponding network node 13, the processing circuitry 1301, and/or the transmitting unit 1303 may be configured to transmit the indication by transmitting a feedback message autonomously at every scheduling of data for the UE 10, over the air interface, of the split radio bearer to the first network node 12. The indication may be for communication related to the split radio bearer between the first network node and the two or more corresponding network nodes. The corresponding network node 13, the processing circuitry 1301, and/or the transmitting unit 1303 may be configured to transmit the indication: without receiving a request for said indication or upon receiving a polling message from the first network node 12; periodically; and/or upon fulfilling a condition related to a level of the delay.

The corresponding network node 13 further comprises a memory 1305. The memory 1305 comprises one or more units to be used to store data on, such as indications, configurations, measurements, thresholds, data related to nodes, and applications to perform the methods disclosed herein when being executed, and similar. Furthermore, the corresponding network node 13 may comprise a communication interface 1308 such as comprising a transmitter, a receiver and/or a transceiver, and/or one or more antennas.

The methods according to the embodiments described herein for the corresponding network node 13 are respectively implemented by means of e.g. a computer program product 1306 or a computer program, comprising instructions, i.e., software code portions, which, when executed on at least one processor, cause the at least one processor to carry out the actions described herein, as performed by the corresponding network node 13. The computer program product 1306 may be stored on a computer-readable storage medium 1307, e.g., a disc, a universal serial bus (USB) stick or similar. The computer-readable storage medium 1307, having stored thereon the computer program product, may comprise the instructions which, when executed on at least one processor, cause the at least one processor to carry out the actions described herein, as performed by the corresponding network node 13. In some embodiments, the computer-readable storage medium may be a transitory or a non-transitory computer-readable storage medium. Thus, embodiments herein may disclose a corresponding network node 13 for handling communication in a wireless communications network, wherein the corresponding network node 13 comprises processing circuitry and a memory, said memory comprising instructions executable by said processing circuitry whereby said corresponding network node 13 is operative to perform any of the methods herein.

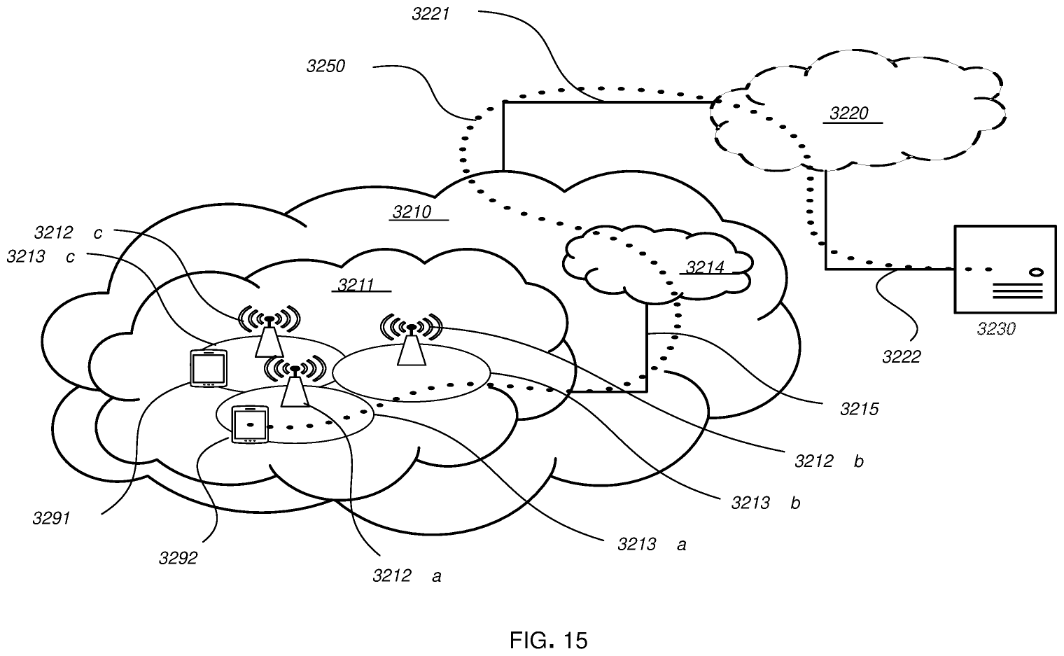

FIGS. 14a-14b are block diagrams depicting the first network node 12 such as a CU, hosting the PDCP entity for handling communication of the UE 10 in the wireless communications network 1 according to embodiments herein.

The first network node 12 may comprise processing circuitry 1401, e.g. one or more processors, configured to perform the methods herein.

The first network node 12 may comprise a receiving unit 1402, e.g. a receiver and/or a transceiver. The first network node 12, the processing circuitry 1401, and/or the receiving unit 1402 is configured to receive from one or more corresponding network nodes, the indication of the delay related to scheduling of data communication over the air interface between respective corresponding network node and the UE 10. The indication may comprise the value indicating the delay, being an expected air interface scheduling delay of the respective corresponding network node.

The first network node 12 may comprise a performing unit 1403. The first network node 12, the processing circuitry 1401, and/or the performing unit 1403 is configured to perform the one or more actions related to aggregating PDCP communication over the split radio bearer between the first network node 12 and two or more corresponding network nodes based on the received indication. The first network node 12, the processing circuitry 1401, and/or the performing unit 1403 may be configured to perform the one or more actions by deactivating or activating the PDCP aggregation at the first network node 12. The one or more actions may comprise: prohibiting PDCP aggregation; giving higher priority to radio bearer in a loaded corresponding network node; and/or performing earlier transmission of one or more packets.

The first network node 12 may comprise a determining unit 1404. The indication may comprise feedback messages and the first network node 12, the processing circuitry 1401, and/or the determining unit 1404 may be configured to determine the delay being an expected air interface scheduling delay of the respective corresponding network node, based on the received feedback messages. The first network node 12, the processing circuitry 1401, and/or the determining unit 1404 may be configured to compare the indicated delay with the threshold and when exceeding the threshold the first network node 12, the processing circuitry 1401, and/or the performing unit 1403 may be configured to perform the one or more actions.

The first network node 12 further comprises a memory 1405. The memory 1405 comprises one or more units to be used to store data on, such as indications, headers, identities, signal measurements, thresholds, data related to nodes, and applications to perform the methods disclosed herein when being executed, and similar. Furthermore, the first network node 12 may comprise a communication interface 1406 such as comprising a transmitter, a receiver and/or a transceiver, and/or one or more antennas.

The methods according to the embodiments described herein for the first network node 12 are respectively implemented by means of e.g. a computer program product 1407 or a computer program, comprising instructions, i.e., software code portions, which, when executed on at least one processor, cause the at least one processor to carry out the actions described herein, as performed by the first network node 12. The computer program product 1407 may be stored on a computer-readable storage medium 1408, e.g. a disc, a universal serial bus (USB) stick or similar. The computer-readable storage medium 1408, having stored thereon the computer program product, may comprise the instructions which, when executed on at least one processor, cause the at least one processor to carry out the actions described herein, as performed by the first network node 12. In some embodiments, the computer-readable storage medium may be a transitory or a non-transitory computer-readable storage medium. Thus, embodiments herein may disclose a first network node 12 for handling communication in a wireless communications network, wherein the first network node 12 comprises processing circuitry and a memory, said memory comprising instructions executable by said processing circuitry whereby said first network node 12 is operative to perform any of the methods herein.

In some embodiments a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are IoT capable device, target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

### Over The Top (OTT)

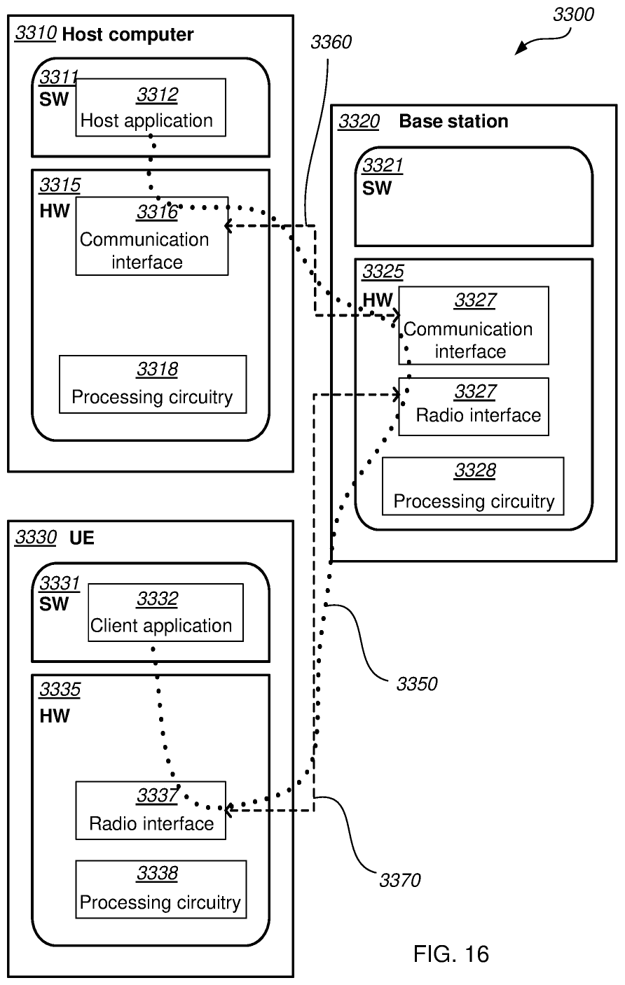

FIG. 15 shows a Telecommunication network connected via an intermediate network to a host computer in accordance with some embodiments. With reference to FIG. 18, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the network nodes above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the wireless device 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 15 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signalling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

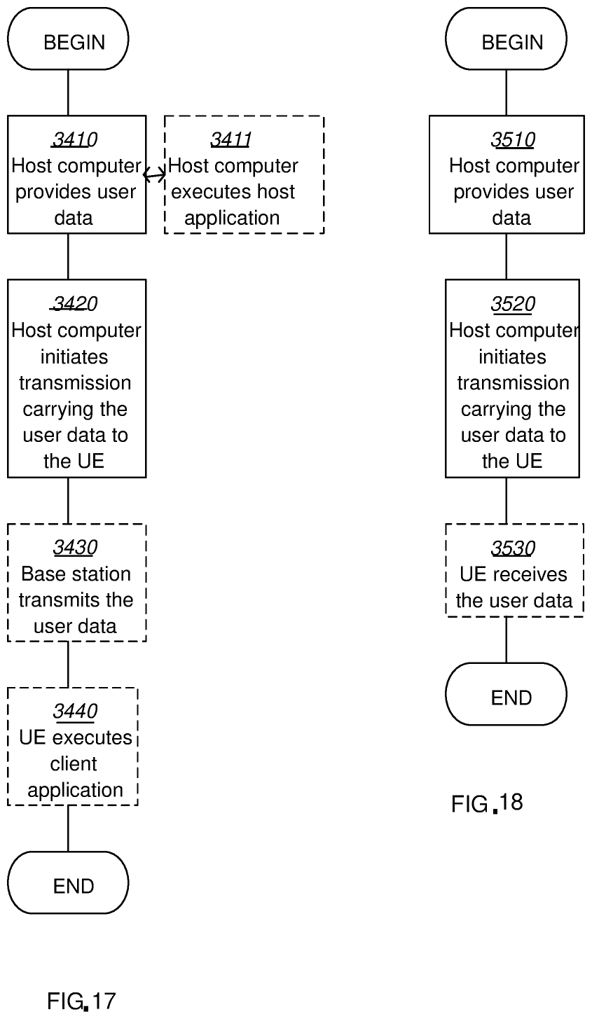

FIG. 16 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 16. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 16) served by base station 3320. Communication interface 3326 may be configured to facilitate connection 3360 to host computer 3310. Connection 3360 may be direct or it may pass through a core network (not shown in FIG. 16) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 16 may be similar or identical to host computer 3230, one of base stations 3212a, 3212b, 3212c and one of UEs 3291, 3292 of FIG. 15, respectively. This is to say, the inner workings of these entities may be as shown in FIG. 16 and independently, the surrounding network topology may be that of FIG. 15.

In FIG. 16, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments make it possible for handling or managing communication related to PDCP aggregation in an efficient manner resulting in a reduced delay of packet transmissions and a quick responsiveness.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signalling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

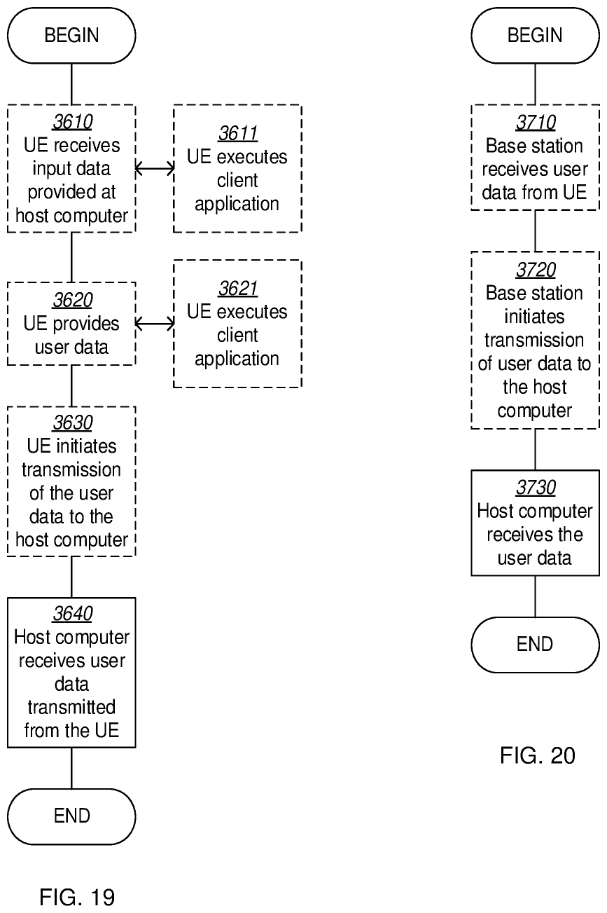

FIG. 17 shows methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIG. 15 and FIG. 16. For simplicity of the present disclosure, only drawing references to FIG. 17 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 18 shows methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIG. 15 and FIG. 16. For simplicity of the present disclosure, only drawing references to FIG. 18 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

FIG. 19 shows methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIG. 15 and FIG. 16. For simplicity of the present disclosure, only drawing references to FIG. 19 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 20 show methods implemented in a communication system including a host computer, a base station and a user equipment in accordance with some embodiments.

FIG. 20 is a flowchart illustrating a method implemented in a communication system, in accordance with one embodiment. The communication system includes a host computer, a base station and a UE which may be those described with reference to FIG. 15 and FIG. 16. For simplicity of the present disclosure, only drawing references to FIG. 20 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate actions, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviations Explanation

AID Assistance Information Data
DC Dual Connectivity
DDDS DL Data Delivery Status
DL DownLink
FC Flow Control
gNB-CU-CP gNB Central Unit-Control Plane
gNB-CU-UP gNB Central Unit-User Plane
gNB-DU gNB Distributed Unit
PDCP Packet Data Convergence Protocol
PDU Packet Data Unit
RB Radio Bearer
RLC Radio Link Control protocol
SDU Segment Data Unit
TCP Transmission Control Protocol

1. A method performed by a first network node hosting a packet data convergence protocol, PDCP, entity for handling communication of a user equipment, UE, in a wireless communications network, the method comprising:
receiving from one or more corresponding network nodes, an indication of a delay related to scheduling of data communication over an air interface between respective corresponding network node and the UE; and
performing one or more actions related to aggregating PDCP communication over a split radio bearer between the first network node and two or more corresponding network nodes based on the received indication.

2. The method according to claim 1, wherein the indication comprises a value indicating the delay being an expected air interface scheduling delay of the respective corresponding network node.

3. The method according to claim 1, wherein the indication comprises feedback messages and the method further comprises determining the delay, being an expected air interface scheduling delay of the respective corresponding network node, based on the received feedback messages.

4. The method according to claim 1, wherein performing the one or more actions comprises deactivating or activating a PDCP aggregation at the first network node.

5. The method according to claim 1, wherein performing the one or more actions comprises: prohibiting PDCP aggregation; giving higher priority to radio bearer in a loaded corresponding network node; and/or performing earlier transmission of one or more packets.

6. The method according to claim 1, further comprising:
comparing the indicated delay with a threshold and when exceeding the threshold performing the one or more actions.

7. A method performed by a corresponding network node for handling communication of a user equipment, UE, in a wireless communications network, the method comprising:
transmitting to a first network node hosting a packet data convergence protocol, PDCP, entity for the corresponding network node, an indication of a delay related to scheduling of data communication over an air interface to the UE.

8. The method according to claim 7, wherein the indication comprises a value indicating the delay being an expected air interface scheduling delay of the corresponding network node.

9. The method according to claim 7, further comprising:
determining the delay at the corresponding network node.

10. The method according to claim 7, wherein transmitting the indication comprises transmitting the indication upon fulfilling a condition related to a level of the delay.

11. The method according to claim 7, wherein transmitting the indication comprises transmitting a feedback message autonomously at every scheduling of data for the UE of a split radio bearer to the first network node.

12. The method according to claim 7, wherein the indication is for communication related to a split radio bearer between the first network node and two or more corresponding network nodes.

13. The method according to claim 7, wherein the indication is: transmitted without receiving a request for said indication or upon receiving a polling message from the first network node; transmitted periodically; and/or transmitted upon fulfilling a condition related to a level of the delay.

14. A first network node hosting a packet data convergence protocol, PDCP, entity for handling communication of a user equipment, UE, in a wireless communications network, the first network node comprising:
at least one processor;
memory coupled with the at least one processor, wherein the memory includes instructions that when executed by the at least one processor causes the first network node to perform operations comprising:
receive from one or more corresponding network nodes, an indication of a delay related to scheduling of data communication over an air interface between respective corresponding network node and the UE; and
perform one or more actions related to aggregating PDCP communication over a split radio bearer between the first network node and two or more corresponding network nodes based on the received indication.

15. The first network node according to claim 14, wherein the indication comprises a value indicating the delay being an expected air interface scheduling delay of the respective corresponding network node.

16. The first network node according to claim 14, wherein the indication comprises feedback messages and the first network node is configured to determine the delay being an expected air interface scheduling delay of the respective corresponding network node, based on the received feedback messages.

17. The first network node according to claim 14, wherein the first network node is configured to perform the one or more actions by deactivating or activating a PDCP aggregation at the first network node.

18. The first network node according to claim 14, wherein the one or more actions comprises: prohibiting PDCP aggregation; giving higher priority to radio bearer in a loaded corresponding network node; and/or performing earlier transmission of one or more packets.

19. The first network node according to claim 14, wherein the first network node is configured to perform operations further comprising:
compare the indicated delay with a threshold and when exceeding the threshold the first network node is configured to perform the one or more actions.

20.-28. (canceled)
